(19) United States
(12) Patent Application Publication
(10) Pub. No.: US 2003/0143358 A1
(43) Pub. Date: Jul. 31, 2003

(54) Vehicle floor mats

(76) Inventor: Marc Needles, Roseville, CA (US)

Correspondence Address: OPPEDAHL AND LARSON LLP, P O BOX 5068, DILLON, CO, 80435-5068, US

(21) Appl. No.: 09/683,655

(22) Filed: Jan. 30, 2002

(51) Int. Cl. B32B 3/02

(52) U.S. Cl. 428/43; 428/80

(57) ABSTRACT

Vehicle floor mats for the front driver's side, the front passenger's side, and the rear driver's or passenger's side, are provided individually or packaged together in a kit containing one each of the front driver's side mat and the front passenger's side mat and two of the rear driver's or passenger's side mats. The mats are formed from a paper board product and have features, such as cut-out regions, cut lines, fold lines, a directional rigidity and a directional flexibility, which provide for a snug, customizable fit without slippage or wrinkling.

### BACKGROUND OF INVENTION

This invention relates to the field of vehicle floor mats and more particularly to floor mats that are absorbent and are able to protect the carpeting of a vehicle.

Car manufacturers have commonly designed and fabricated flexible, waterproof floor mats for each model of car. These mats are intended to protect the floor carpeting of the vehicle from staining, soiling, and discoloration. Unfortunately, these mats become stained, soiled, and discolored and generally can not be restored to an unblemished condition. The result is that the floor mats become an eye sore and possibly take on foul odors. New mats can generally be ordered from the car manufacturer for a period of time, but the price is somewhat high. For a person who lives or works in an environment frequently containing contaminants, such as mud, clay, snow and grease, the cost of replacing floor mats on a frequent basis can be quite substantial.

One solution to this problem has been offered in the form of relatively cheap generic floor mats to replace the ones produced by the car manufacturer once they have become unsightly. There are two problems with this solution. One is that the generic floor mats can still be relatively costly for someone who needs to replace them on a frequent basis. Second is that these floor mats are usually flimsy and tend to shift and wrinkle under the driver's or passenger's feet. This can prove hazardous if the mat wrinkles under the pedals such as to inhibit the engagement of the pedals. Additionally, the floor may no longer be protected when the mat shifts or wrinkles.

Another solution which has been offered in response to this problem is replaceable covers for floor mats. One such cover is described in U.S. Pat. No. 3,663,980 issued May 23, 1972. This patent discloses a soft fabric cover that encloses the top side of a floor mat and is removably secured to the underside of the mat by a hook fabric fastener strip engaged by a strip of matted fabric attached to the underside of the floor mat. Another such floor mat cover was described in U.S. Pat. No. 6,294,240 issued on Sep. 25, 2001. An elastic strip is used to secure that cover to the floor mat.

Another solution that has been offered is disposable, roll-up temporary floor mats as described in U.S. Pat. Nos. 5,236,753 and 5,149,572 issued on Aug. 17, 1993 and Sep. 22, 1992, respectively. These floor mats are made up of two layers of cardboard, one of which is corrugated. The floor mats are relatively inexpensive and can be rolled up for easy disposal.

Along a similar line, garages frequently use a temporary, disposable paper mats to protect the vehicle floor while the car is being serviced. While these paper mats are inexpensive, they are far too flimsy and susceptible to wrinkling to be used during regular vehicle use. An inexpensive, but safer and more durable floor mat is needed.

### SUMMARY OF INVENTION

This invention relates to vehicle floor mats for the front driver's side, the front passenger's side, and the rear driver's or passenger's side, individually and packaged together in a kit containing one each of the front driver's side mat and the front passenger's side mat and two of the rear driver's or passenger's side mats. The mats are formed from a relatively inexpensive paper board product and have features, such as cut-out regions, cut lines, fold lines, a directional rigidity and a directional flexibility, which provide for a snug, customizable fit without slippage or wrinkling.

### BRIEF DESCRIPTION OF DRAWINGS

FIG. 1 shows a top view of the front driver's side vehicle floor mat (sometimes referred to as floor mat A).

FIG. 2 shows a top view of the front passenger's side vehicle floor mat (sometimes referred to as floor mat B).

FIG. 3 shows a top view of the rear driver's or passenger's side vehicle floor mat (sometimes referred to as floor mat C).

FIG. 4 shows a back side view of the front driver's side vehicle floor mat.

FIG. 5 shows a left-side view of the front driver's side vehicle floor mat.

### DETAILED DESCRIPTION

This invention relates to vehicle floor mats manufactured from a paper board product (as defined below) for the front driver's side, the front passenger's side, and the rear driver's or passenger's side, individually and packaged together in a kit containing one each of the front driver's side mat and the front passenger's side mat and two of the rear driver's or passenger's side mats. The mats have features, such as optional cut-out regions, cut lines, fold lines, a directional rigidity and a directional flexibility, which provide for a snug, customizable fit without slippage or wrinkling.

The terms optional cut-out regions, cut lines, fold lines, directional rigidity and directional flexibility as used in this application are defined as follows. An optional cut-out region is a portion of the mat that may be removed from the rest of the mat. The optional cut-out region is demarcated on the mat by some means, such as ink lines, perforations on one or both sides, or indentations, indicating where the mat may be cut in order to remove the optional cut-out region. There may also be a symbol or words on the mat indicating where to cut. The optional cut-out region can be removed by cutting along the demarcation using scissors, a knife, or some other cutting instrument, or by punching out the region when perforations on both sides have been used for the demarcation.

Similarly, cut lines are lines along which one may cut in order to change the shape or sizing of the mat. The cut lines are demarcated on the mat by some means, such as ink lines, perforations on one or both sides, or indentations, indicating where the mat may be cut. There may also be a symbol or words on the mat indicating where to cut. Cutting can be accomplished using scissors, a knife, or some other cutting instrument along the cut line, or by punching through the cut line when perforations on both sides have been used for the demarcation.

Fold lines are areas of the mat that may be bent or crushed in order to better fit the contouring of the vehicle floor. The fold lines are demarcated on the mat by some means, such as ink lines, perforations on one or both sides, or indentations, indicating where the mat may be folded. There may also be a symbol or words on the mat indicating where to fold. Folding can be accomplished by bending or crushing the mat along the fold line. Applicants have found that perforations on both sides of the mat is a preferable form for demarcation of the fold lines, cut lines, and optional cut-out regions since it tends to make cutting and folding easier.

Directional rigidity is defined as a property of the material that lends rigidity or resistance to bending to the mat in a particular direction. Directional flexibility is defined as a property of the material that lends flexibility or little resistance to bending in a particular direction.

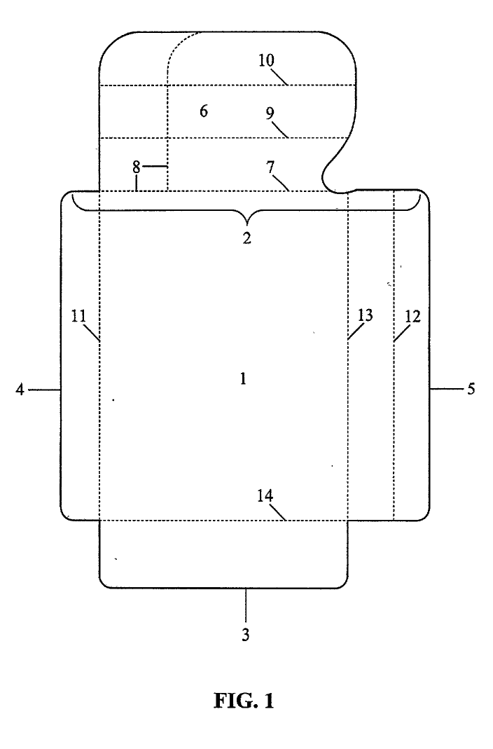

Floor Mat A. A top view of the front driver's side vehicle floor mat (sometimes referred to as floor mat A) is shown in FIG. 1. The mat is formed from a paper board product and has a substantially rectangular main body portion 1, which has a front edge 2, a back edge 3, a left-side edge 4, and a right-side edge 5. The main body portion has a directional rigidity that exists in a direction running from the front edge 2 to the back edge 3 and has a directional flexibility that exists in a direction running from the left-side edge 4 to the right-side edge 5. The main purpose of the directional rigidity is to prevent slippage and wrinkling of the mat, especially when the driver is entering and exiting the vehicle. This prevents the hazardous condition that is produced when a mat slips forward and wrinkles under the pedals, thus making it difficult to engage the pedals properly. The main purpose for having directional flexibility from side to side is to allow for a more customizable fit over the contours of the vehicle floor by allowing for easy bending of the mat where needed.

The mat also has a tab portion 6, which has a smaller width than the width of the main body portion, extending from the front edge 2 of the main body portion in a centralized location such that a left and a right shoulder of the front edge 2 extend beyond the tab portion 6 on each side. This tab portion 6 is designed to extend behind the pedals to some degree to provide protection to the vehicle floor in that area.

A cut-out region is formed by the removal of a portion of the right-most side of the tab portion 6 where it joins the front edge 2 of the main body portion and removal of a portion of the right shoulder of the main body portion 1. The cut-out region is preferably curved and is formed for the purpose of fitting around the vehicle's pedals on the driver's side.

Additionally, the mat has a first fold line 7 formed therein, which is co-linear with the front edge 2 of the main body portion, and joins the main body portion 1 with the tab portion 6. This first fold line 7 allows the front edge 2 to rest against the firewall of the vehicle, thereby, preventing slippage and excess movement of the floor mat while being used.

The floor mat may have several additional features that are designed to customize and to enhance the fit and placement of the floor mat. One such additional feature is an optional cut-out region on the left-most side of the tab portion 6. This optional cut-out region is delineated by a perforated line 8 on the tab portion 6 extending along the first fold line 7 from the left-most edge of the tab portion and extending perpendicularly from the first fold line 7 to a front edge of the tab portion 6. Preferably, the optional cut-out region is delineated by a perforated line 8 extending between approximately one and seven inches along the first fold line 7 from the leftmost edge of the tab portion and extending perpendicularly from the first fold line 7 to a front edge of the tab portion 6. More preferably, the optional cut-out region is delineated by a perforated line 8 extending approximately four inches along the first fold line 7 from the left-most edge of the tab portion and extending perpendicularly from the first fold line 7 to a front edge of the tab portion 6.

To enhance the fit along the contours of the firewall under the pedal region, the floor mat may also have a second 9 and/or a third fold line 10 on the tab portion 6. The second and/or third fold lines run parallel to the first fold line 7, and are preferably separated by approximately equal distances dividing the tab portion 6 approximately into thirds.

The floor mat may also contain a fourth fold line 11 on the main body portion 1 running parallel with the left-side edge 4. The fourth fold line 11 is preferably located approximately between one-half and six inches from the left-side edge 4. More preferably, the fourth fold line 11 is located approximately one and one-half inches from the left-side edge 4. This fourth fold line 11 allows the mat to be bent to fit the contour of the vehicle floor next to the door and to allow the mat to extend up along the floor, thus protecting the floor side.

The floor mat may additionally contain a fifth fold line 12 on the main body portion 1 running parallel with the right-side edge S. The fifth fold line 12 is preferably located approximately between one-half and three inches from the right-side edge 5. More preferably, the fifth fold line 12 is located approximately one and one-half inches from the right-side edge 5.

The floor mat may contain a sixth fold line 13 on the main body portion 1 running parallel with the right-side edge 5. The sixth fold line 13 is preferably located approximately between one and one-half and six inches from the right-side edge 5. More preferably, the sixth fold line 13 is located approximately three and three-fourths inches from the right-side edge 5. The fifth fold line 12 and sixth fold line 13 allow the mat to be bent to fit the contour of the vehicle floor next to the center hump or gear shift and to allow the mat to extend up along the floor, thus protecting the floor side.

The floor mat may also contain a seventh fold line 14 on the main body portion 1 extending from the left-side edge 4 to the right-side edge 5 parallel with the back edge 3. The seventh fold line 14 is preferably located approximately between one-half and ten inches from the back edge 3, and more preferably, it is located approximately three inches from the back edge 3 on the main body portion 1. The seventh fold line 14 allows the mat to be easily folded to provide a better fit for some vehicles.

The floor mat may also contain one or two additional cut-out regions on the main body portion 1 formed by the removal of one or two portions of the main body portion 1. One of these cut out regions is formed by the removal of a left, back-side corner of the main body portion 1 from the left-side edge 4 along the seventh fold line 14 to the fourth fold line 11 and then along the fourth fold line 11 to the back edge 3. The other of these cut out regions is formed by the removal of a right, backside corner of the main body portion 1 from the right-side edge 5 along the seventh fold line 14 to the sixth fold line 13 and then along the sixth fold line 13 to the back edge 3. These cut out regions may provide a better fit for some vehicles.

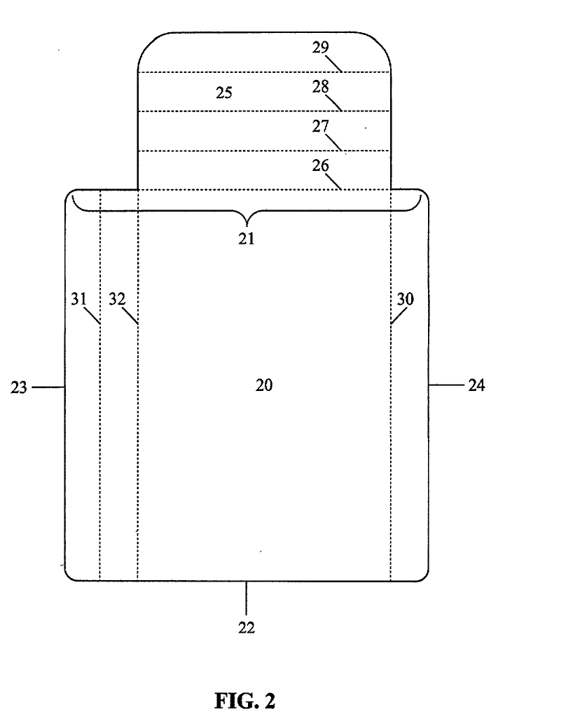

Floor Mat B. A top view of the front passenger's side vehicle floor mat (sometimes referred to as floor mat B) is shown in FIG. 2. The mat is formed from a paper board product and has a substantially rectangular main body portion 20, which has a front edge 21, a back edge 22, a left-side edge 23, and a right-side edge 24. The main body portion 20 has a directional rigidity that exists in a direction running from the front edge 21 to the back edge 22 and has a directional flexibility that exists in a direction running from the left-side edge 23 to the right-side edge 24. The main purpose of the directional rigidity is to prevent slippage and wrinkling of the mat, especially when the passenger is entering and exiting the vehicle. The main purpose for having directional flexibility from side to side is to allow for a more customizable fit over the contours of the vehicle floor by allowing for easy bending of the mat where needed.

The mat also has a tab portion 25, which has a smaller width than the width of the main body portion 20, extending from the front edge 21 of the main body portion in a centralized location such that a left and a right shoulder of the front edge 21 extend beyond the tab portion 25 on each side. This tab portion is designed to extend up the firewall to some degree to provide protection to the vehicle floor in that area.

Additionally, the mat has a first fold line 26 formed therein, which is co-linear with the front edge 21 of the main body portion, and joins the main body portion 20 with the tab portion 25. This first fold line 26 allows the front edge 21 to rest against the firewall of the vehicle, thereby, preventing slippage and excess movement of the floor mat while being used.

The floor mat may have several additional features that are designed to customize and to enhance the fit and placement of the floor mat. One such additional feature is a fold line. To enhance the fit along the contours of the firewall, the floor mat may also have a second 27, a third fold line 28, and/or a fourth fold line 29 on the tab portion 25. These fold lines run parallel to the first fold line 26, and are preferably separated by approximately equal distances dividing the tab portion 25 approximately into fourths.

The floor mat may also contain a fifth fold line 30 on the main body portion 20 running parallel with the right-side edge 24. The fifth fold line 30 is preferably located approximately between one-half and six inches from the right-side edge 24. More preferably, the fifth fold line 30 is located approximately one and one-half inches from the right-side edge 24. This fifth fold line 30 allows the mat to be bent to fit the contour of the vehicle floor next to the door and to allow the mat to extend up along the floor, thus protecting the floor side.

The floor mat may additionally contain a sixth fold line 31 and/or a seventh fold line 32 on the main body portion 20 running parallel with the left-side edge 23. The sixth fold line 31 is preferably located approximately between one-half and three inches from the left-side edge 23. More preferably, the sixth fold line 31 is located approximately one and one-half inches from the left-side edge 23.

The seventh fold line 32 is preferably located approximately between one and one-half and six inches from the left-side edge 23. More preferably, the seventh fold line 32 is located approximately three and one-half inches from the left-side edge 23. The sixth fold line 31 and seventh fold line 32 allow the mat to be bent to fit the contour of the vehicle floor next to the center hump or gear shift and to allow the mat to extend up along the floor, thus protecting the floor side.

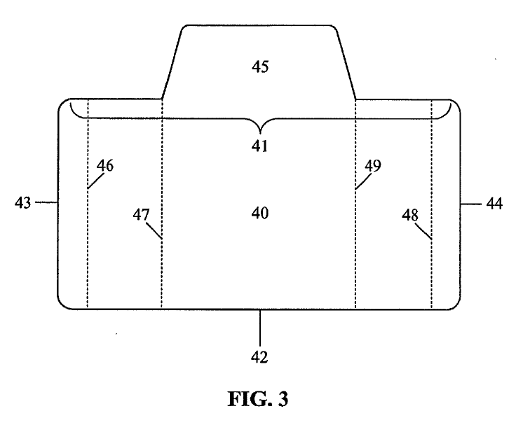

Floor Mat C. A top view of the rear driver's and/or passenger's side vehicle floor mat (sometimes referred to as floor mat C) is shown in FIG. 3. The mat is formed from a paper board product and has a substantially rectangular main body portion 40 with the front edge and the back edge each nearly two-times longer than either the left-side edge or the right-side edge, which has a front edge 41, a back edge 42, a left-side edge 43, and a right-side edge 44. The main body portion 40 has a directional rigidity that exists in a direction running from the front edge 41 to the back edge 42 and has a directional flexibility that exists in a direction running from the left-side edge 43 to the right-side edge 44. The main purpose of the directional rigidity is to prevent slippage and wrinkling of the mat, especially when the passenger is entering and exiting the vehicle. The main purpose for having directional flexibility from side to side is to allow for a more customizable fit over the contours of the vehicle floor by allowing for easy bending of the mat where needed.

The mat also has a tab portion 45, which has a smaller width than the width of the main body portion 40, extending from the front edge 41 of the main body portion 40 in a centralized location such that a left and a right shoulder of the front edge 41 extend beyond the tab portion 45 on each side. This mat is designed so that the left and right shoulders rest against the seat brackets of the front seat and the tab portion extends under the front seat to some degree to provide protection to the vehicle floor in that area.

The floor mat may have additional features, such as fold lines, that are designed to customize and to enhance the fit and placement of the floor mat. The floor mat may have a first fold line 46 and/or a second fold line 47 on the main body portion 40 running parallel with the left-side edge 43. The first fold line 46 is preferably located approximately between one-half and four inches from the left-side edge 43. More preferably, the first fold line 46 is located approximately one and one-half inches from the left-side edge 43. The second fold line 47 is preferably located approximately between one and one-half and six inches from the left-side edge 43. More preferably, the second fold line 47 is located approximately five inches from the left-side edge 43.

The floor mat may have a third fold line 48 and/or a fourth fold line 49 on the main body portion 40 running parallel with the right-side edge 44. The third fold line 48 is preferably located approximately between one-half and four inches from the right-side edge 44. More preferably, the third fold line 48 is located approximately one and one-half inches from the right-side edge 44. The fourth fold line 49 is preferably located approximately between one and one-half and six inches from the right-side edge 44. More preferably, the fourth fold line 49 is located approximately five inches from the right-side edge 44.

Kit. The floor mats as described above may be offered individually or in the form of a kit comprising some form of packaging material containing one floor mat A, one floor mat B, and two floor mats C. All of the same characteristics and optional features as described above apply to the floor mats packaged as a kit.

Floor Mat Material. The paper board product from which floor mats A, B, and C are manufactured can be defined as any paper board product comprising at least three sheets layered and adhered together such that a first sheet forms an upper surface, a second sheet forms a lower surface, and a third sheet along with any additional sheets form a center layer that is sandwiched between the upper and lower surfaces. The center layer has at least one corrugated sheet. Preferably, the paper board product contains three sheets layered and adhered together such that a first sheet forms an upper surface, a second sheet forms a lower surface, and a third sheet forms a center layer that is sandwiched between the upper and lower surfaces. It is also preferable that the upper surface and the lower surface are substantially planar, and the center layer is corrugated.

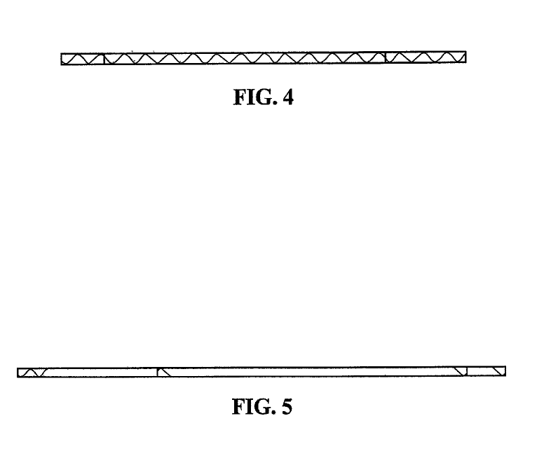

It is also preferable that the corrugations of the center layer are positioned such that tubes are formed that run substantially parallel with the left- and right-side edges, as shown in FIGS. 4 and 5. FIG. 4, which shows a back side view of the front driver's side vehicle floor mat, shows how the tubes are positioned such that they are substantially open on the front and back sides. FIG. 5, which shows a left-side view of the front driver's side vehicle floor mat, shows that the tubes are positioned such that they are substantially closed from the left and right sides. The purpose for having the tubes positioned in this way is to enhance the directional rigidity of the main body portion that exists in a direction running from the front edge to the back edge and the directional flexibility that exists in a direction running from the left-side edge to the right-side edge. The directional rigidity from front to back helps to prevent slippage and wrinkling of the mat. This prevents the hazardous condition that is produced when a mat slips forward and wrinkles under the pedals, thus making it difficult to engage the pedals properly. The directional flexibility from side to side allows for a more customizable fit over the contours of the vehicle floor by allowing for easy bending of the mat where needed. An optional embodiment of the invention is to have the corrugations of the center layer run substantially diagonally with respect to a line running parallel with the left- and right-side edges. This embodiment would afford rigidity front to back and side to side, but the side to side flexibility would be diminished.

1. A front driver's side vehicle floor mat formed from a paper board product, said floor mat consisting of:
a substantially rectangular main body portion having a front edge, a back edge, a left-side edge, and a right-side edge and having a directional rigidity that exists in a direction running from the front edge to the back edge and having a directional flexibility that exists in a direction running from the left-side edge to the right-side edge;
a tab portion, said tab portion having a smaller width than the width of the main body portion and extending from the front edge of the main body portion in a centralized location such that a left and a right shoulder of the front edge extend beyond the tab portion on each side, said tab portion having a cut-out region formed by the removal of a portion of the right-most side of the tab portion where it joins the front edge of the main body portion and removal of a portion of the right shoulder of the main body portion; and
wherein the mat has a first fold line formed therein, which is co-linear with the front edge of the main body portion, and joins the main body portion with the tab portion.

2. The floor mat of claim 1, wherein the paper board product contains at least three sheets layered and adhered together such that a first sheet forms an upper surface, a second sheet forms a lower surface, and a third sheet along with any additional sheets form a center layer that is sandwiched between the upper and lower surfaces.

3. The floor mat of claim 2, wherein the upper surface and the lower surface are substantially planar, and all or part of the center layer is corrugated.

4. The floor mat of claim 3, wherein the corrugations of the center layer are positioned such that tubes are formed that run substantially parallel with the left- and right-side edges.

5. The floor mat of claim 3, wherein the corrugations of the center layer run substantially diagonally with respect to a line running parallel with the left- and right-side edges.

6. The floor mat of claim 1, additionally comprising a perforated line on the tab portion extending along the first fold line from the left-most edge of the tab portion and extending perpendicularly from the first fold line to a front edge of the tab portion, thereby delineating an optional cut-out region on the left-most side of the tab portion.

7. The floor mat of claim 1, additionally comprising a second and a third fold line on the tab portion, said second and third fold lines running parallel to the first fold line and separated by approximately equal distances dividing the tab portion approximately into thirds.

8. The floor mat of claim 1, additionally comprising a fourth fold line on the main body portion running parallel with the left-side edge.

9. The floor mat of claim 8, additionally comprising a fifth fold line on the main body portion running parallel with the right-side edge.

10. The floor mat of claim 9, additionally comprising a sixth fold line on the main body portion running parallel with the right-side edge.

11. The floor mat of claim 10, additionally comprising a seventh fold line on the main body portion extending from the left-side edge to the right-side edge parallel with the back edge.

12. The floor mat of claim 11, additionally comprising two cut-out regions on the main body portion formed by the removal of two portions of the main body portion, wherein the first of the cut out regions is formed by the removal of a left, back-side corner of the main body portion from the left-side edge along the seventh fold line to the fourth fold line and then along the fourth fold line to the back edge, and wherein the second of the cut out regions is formed by the removal of a right, back-side corner of the main body portion from the right-side edge along the seventh fold line to the sixth fold line and then along the sixth fold line to the back edge.

13. A front passenger's side vehicle floor mat formed from a paper board product, said floor mat comprising:
a substantially rectangular main body portion having a front edge, a back edge, a left-side edge, and a right-side edge and having a directional rigidity that exists in a direction running from the front edge to the back edge and having a directional flexibility that exists in a direction running from the left-side edge to the right-side edge;
a tab portion, said tab portion having a smaller width than the width of the main body portion and extending from the front edge of the main body portion in a centralized location such that a left and a right shoulder of the front edge extend beyond the tab portion on each side; and
wherein the mat has a first fold line formed therein, which is co-linear with the front edge of the main body portion, and joins the main body portion with the tab portion.

14. The floor mat of claim 13, wherein the paper board product comprises at least three sheets layered and adhered together such that a first sheet forms an upper surface, a second sheet forms a lower surface, and a third sheet along with any additional sheets form a center layer that is sandwiched between the upper and lower surfaces.

15. The floor mat of claim 14, wherein the upper surface and the lower surface are substantially planar, and all or part of the center layer is corrugated.

16. The floor mat of claim 15, wherein the corrugations of the center layer are positioned such that tubes are formed that run substantially parallel with the left- and right-side edges.

17. The floor mat of claim 15, wherein the corrugations of the center layer run substantially diagonally with respect to a line running parallel with the left- and right-side edges.

18. The floor mat of claim 13, additionally comprising a second, a third, and a fourth fold line on the tab portion, said second, third, and fourth fold lines running parallel to the first fold line and separated by approximately equal distances dividing the tab portion approximately into fourths.

19. The floor mat of claim 13, additionally comprising a fifth fold line on the main body portion running parallel with the right-side edge.

20. The floor mat of claim 13, additionally comprising a sixth fold line on the main body portion running parallel with the left-side edge.

21. The floor mat of claim 13, additionally comprising a seventh fold line on the main body portion running parallel with the left-side edge.

22. A rear driver's or passenger's side vehicle floor mat formed from a paper board product, said floor mat comprising:
a substantially rectangular main body portion having a front edge, a back edge, a left-side edge, and a right-side edge, with the front edge and the back edge each nearly two-times longer than either the left-side edge or the right-side edge, and having a directional rigidity that exists in a direction running from the front edge to the back edge and having a directional flexibility that exists in a direction running from the left-side edge to the right-side edge; and
a tab portion, said tab portion having a smaller width than the width of the main body portion and extending from the front edge of the main body portion in a centralized location such that a left and a right shoulder of the front edge extend beyond the tab portion on each side.

23. The floor mat of claim 22, wherein the paper board product comprises at least three sheets layered and adhered together such that a first sheet forms an upper surface, a second sheet forms a lower surface, and a third sheet along with any additional sheets form a center layer that is sandwiched between the upper and lower surfaces.

24. The floor mat of claim 23, wherein the upper surface and the lower surface are substantially planar, and all or part of the center layer is corrugated.

25. The floor mat of claim 24, wherein the corrugations of the center layer are positioned such that tubes are formed that run substantially parallel with the left- and right-side edges.

26. The floor mat of claim 24, wherein the corrugations of the center layer run substantially diagonally with respect to a line running parallel with the left- and right-side edges.

27. The floor mat of claim 22, additionally comprising a first fold line on the main body portion running parallel with the left-side edge.

28. The floor mat of claim 22, additionally comprising a second fold line on the main body portion running parallel with the left-side edge.

29. The floor mat of claim 22, additionally comprising a third fold line on the main body portion running parallel with the right-side edge.

30. The floor mat of claim 22, additionally comprising a fourth fold line on the main body portion running parallel with the right-side edge.

31. A kit comprising packaging containing one floor mat A, one floor mat B, and two floor mats C, wherein
floor mat A is a front driver's side vehicle floor mat formed from a paper board product, said floor mat comprising:
a substantially rectangular main body portion having a front edge, a back edge, a left-side edge, and a right-side edge and having a directional rigidity that exists in a direction running from the front edge to the back edge and having a directional flexibility that exists in a direction running from the left-side edge to the right-side edge;
a tab portion, said tab portion having a smaller width than the width of the main body portion and extending from the front edge of the main body portion in a centralized location such that a left and a right shoulder of the front edge extend beyond the tab portion on each side, said tab portion having a cut-out region formed by the removal of a portion of the right-most side of the tab portion where it joins the front edge of the main body portion and removal of a portion of the right shoulder of the main body portion; and
wherein the mat has a first fold line formed therein, which is co-linear with the front edge of the main body portion, and joins the main body portion with the tab portion;
floor mat B is a front passenger's side vehicle floor mat formed from a paper board product, said floor mat comprising:
a substantially rectangular main body portion having a front edge, a back edge, a left-side edge, and a right-side edge and having a directional rigidity that exists in a direction running from the front edge to the back edge and having a directional flexibility that exists in a direction running from the left-side edge to the right-side edge;
a tab portion, said tab portion having a smaller width than the width of the main body portion and extending from the front edge of the main body portion in a centralized location such that a left and a right shoulder of the front edge extend beyond the tab portion on each side; and
wherein the mat has a first fold line formed therein, which is co-linear with the front edge of the main body portion, and joins the main body portion with the tab portion; and
floor mats C are rear driver's and passenger's side vehicle floor mats formed from a paper board product, said floor mats comprising:
a substantially rectangular main body portion having a front edge, a back edge, a left-side edge, and a right-side edge, with the front edge and the back edge each nearly two-times longer than either the left-side edge or the right-side edge, and having a directional rigidity that exists in a direction running from the front edge to the back edge and having a directional flexibility that exists in a direction running from the left-side edge to the right-side edge; and
a tab portion, said tab portion having a smaller width than the width of the main body portion and extending from the front edge of the main body portion in a centralized location such that a left and a right shoulder of the front edge extend beyond the tab portion on each side.

32. The floor mats of claim 31, wherein the paper board product comprises at least three sheets layered and adhered together such that a first sheet forms an upper surface, a second sheet forms a lower surface, and a third sheet along with any additional sheets form a center layer that is sandwiched between the upper and lower surfaces.

33. The floor mat of claim 32, wherein the upper surface and the lower surface are substantially planar, and all or part of the center layer is corrugated.

34. The floor mat of claim 33, wherein the corrugations of the center layer are positioned such that tubes are formed that run substantially parallel with the left- and right-side edges.

35. The floor mat of claim 33, wherein the corrugations of the center layer run substantially diagonally with respect to a line running parallel with the left- and right-side edges.

36. The floor mat A of claim 34, additionally comprising a perforated line on the tab portion extending along the first fold line from the left-most edge of the tab portion and extending perpendicularly from the first fold line to a front edge of the tab portion, thereby delineating an optional cut-out region on the left-most side of the tab portion.

37. The floor mat A of claim 36, additionally comprising a second and a third fold line on the tab portion, said second and third fold lines running parallel to the first fold line and separated by approximately equal distances dividing the tab portion approximately into thirds.

38. The floor mat A of claim 37, additionally comprising a fourth fold line on the main body portion running parallel with the left-side edge.

39. The floor mat A of claim 38, additionally comprising a fifth fold line on the main body portion running parallel with the right-side edge.

40. The floor mat A of claim 39, additionally comprising a sixth fold line on the main body portion running parallel with the right-side edge.

41. The floor mat A of claim 40, additionally comprising a seventh fold line on the main body portion extending from the left-side edge to the right-side edge parallel with the back edge.

42. The floor mat A of claim 41, additionally comprising two cut-out regions on the main body portion formed by the removal of two portions of the main body portion, wherein the first of the cut out regions is formed by the removal of a left, back-side corner of the main body portion from the left-side edge along the seventh fold line to the fourth fold line and then along the fourth fold line to the back edge, and wherein the second of the cut out regions is formed by the removal of a right, back-side corner of the main body portion from the right-side edge along the seventh fold line to the sixth fold line and then along the sixth fold line to the back edge.

43. The floor mat B of claim 34, additionally comprising a second, a third, and a fourth fold line on the tab portion, said second, third, and fourth fold lines running parallel to the first fold line and separated by approximately equal distances dividing the tab portion approximately into fourths.

44. The floor mat B of claim 43, additionally comprising a fifth fold line on the main body portion running parallel with the right-side edge.

45. The floor mat B of claim 44, additionally comprising a sixth fold line on the main body portion running parallel with the left-side edge.

46. The floor mat B of claim 45, additionally comprising a seventh fold line on the main body portion running parallel with the left-side edge.

47. The floor mat C of claim 34, additionally comprising a first fold line on the main body portion running parallel with the left-side edge.

48. The floor mat C of claim 47, additionally comprising a second fold line on the main body portion running parallel with the left-side edge.

49. The floor mat C of claim 48, additionally comprising a third fold line on the main body portion running parallel with the right-side edge.

50. The floor mat C of claim 49, additionally comprising a fourth fold line on the main body portion running parallel with the right-side edge.
